(19) United States
(12) Patent Application Publication
(10) Pub. No.: US 2007/0103018 A1
(43) Pub. Date: May 10, 2007

(54) GAS ASPIRATION AND COMPRESSION SYSTEM, ESPECIALLY FOR GAS COMPRESSORS

(75) Inventor: Jose Sarro Alonso, Sant Quirze del Valles (ES)

Correspondence Address: WOLF, BLOCK, SHORR AND SOLIS-COHEN LLP, 250 PARK AVENUE, 10TH FLOOR, NEW YORK, NY, 10177, US

(73) Assignee: Appliances Components Companies Spain, S.A., Sant Quirze del Valles (ES)

(21) Appl. No.: 11/554,962

(22) Filed: Oct. 31, 2006

(30) Foreign Application Priority Data
Nov. 8, 2005 (ES) 200502716

(51) Int. Cl. H02K 5/16

(52) U.S. Cl. 310/90

(57) ABSTRACT

It includes a piston (2) of markedly small diameter associated with a cylinder (3) of a compression chamber (4). It is characterised in that it includes a gas intake port (6) at a lateral zone of the cylinder (3) near the bottom dead centre point of the piston (2), a P-V optimisation valve (7) mounted inside the piston (2), and at least one hole (8) made inside the piston (2) in a radial direction that connects said intake port (6) with the P-V optimisation valve (7), in such a way that the at least one hole (8) is moveable along the intake port (6), permitting entry of the gas towards the compression chamber (4) during the piston intake stroke (2) and closure of the gas during the piston compression stroke (2). Increased energy efficiency of the compressor is achieved and the intake valve in the piston head is eliminated.

The present invention relates to a gas aspiration and compression system, especially for gas compressors.

### BACKGROUND OF THE INVENTION

It is well known that the new challenges posed by safeguarding the environment and, in particular, the requirements of the Kyoto Protocol in relation to climate change, by enforcing a marked reduction in emissions of greenhouse-effect gases by the industrialised countries faces the refrigeration industry with the need to find alternatives to the current HFC (hydrofluorocarbons) type of refrigerants that have a high GWP (Global Warming Potential).

Within this context, CO₂ presents itself as a compound with a good chance of being accepted as a refrigerant in refrigeration cycles by vapour compression. Among the important characteristics of CO₂ are its high working pressures, its high discharge temperatures and its high volumetric capacity. These characteristics mean that in low-pressure aspiration systems cooled by ambient air it is practically necessary to work with two compression stages with intermediate cooling.

In the case of compression in two stages, the high volumetric capacity of the CO₂ leads, for the small power levels of commercial refrigeration, i.e. non-domestic refrigeration, to very low cubic capacities in the second stage, which gives rise to constructional difficulties in building the alternative compressors.

The mechanism of the alternative piston compressors is usually of the connecting rod/crank type. This mechanism requires a joint pin in the central zone of the piston through which the connecting rod transmits to the piston the energy needed to overcome the pressure on the piston head. That joint does not permit the construction of a cylinder with diameters smaller than certain values, thus leading to negligible piston stroke runs for very small cubic capacities. A small stroke/diameter ratio further involves highly variable volumetric output at the working pressure.

Possible solutions to this problem based on the connecting rod/crank mechanism (dual-diameter piston) lead to short connecting rods and major lateral stresses. It therefore becomes necessary to seek alternatives that permit the construction of small cubic capacities with suitable stroke/diameter ratios

A Scotch yoke mechanism, made up of piston, guide, slider and crankshaft eliminates the joint on the piston, allowing it to be manufactured with the desired diameter, no matter how small that might be.

However, it has been found in practice that in the case of small diameters, there is the disadvantage of insufficient space being available to fit all the valves (intake and outlet) in the piston head.

### DESCRIPTION OF THE INVENTION

The objective of the gas aspiration and compression system of the present invention, especially for gas compressors, is to solve the disadvantages presented by the systems known in the art, while providing a number of advantages that will be described below.

The gas aspiration and compression system of the invention, especially for gas compressors, is of the type that includes a piston of considerably small diameter associated with a cylinder of a compression chamber, and is characterised in that it includes a gas intake port in a lateral zone of the cylinder near the bottom dead point of the piston, a P-V optimisation valve mounted inside the piston, and at least one hole made in the piston in a radial direction that connects said intake port with the P-V optimisation valve, in such a way that the at least one hole is movable along the intake port, permitting entry of the gas towards the compression chamber during the intake stroke of the piston and closing of the gas during the compression stroke of the piston.

The arrangement of said intake port permits the design of the intake to be resolved effectively in compressors with cylinders of very small diameter, since it eliminates the utilisation of an intake valve in the piston head.

Furthermore, the layout of the P-V optimisation valve (Pressure-Volume) significantly increases the energy efficiency of the system by breaking the vacuum produced during the withdrawal stroke of the piston.

Advantageously, the at least one hole is positioned in a plane different from that that contains the stresses corresponding to the reaction torque on the piston head and on the rear part of the cylinder. It is thereby possible to prevent a reduction of the guiding surface area of the piston.

Preferably, the P-V optimisation valve is arranged substantially centred in an axial direction inside the piston. As there exists exclusively a compression valve, i.e. the aforesaid P-V optimisation valve, it is possible to place this in a position corresponding to the geometrical centre of the piston cross-section.

According to one embodiment of the present invention, the front part of the P-V optimisation valve includes a projection that can occupy, at the top dead point of the piston, part of the volume of a corresponding discharge port. This projection can thereby permit the dead volume of the compressor chamber to be reduced, thus preventing a potential reduction of the volumetric performance, especially during low intake pressures.

Preferably, the diameter of the piston is less than 11 mm. As noted above, the intake aspiration gas and compression system of the invention is applied particularly in pistons of considerably small diameter.

In accordance with another aspect, the invention also relates to a gas compressor that includes a gas aspiration and compression system of the type defined above.

Preferably, the gas used is CO₂. As observed earlier, CO₂ provides high working pressures, high discharge temperatures and a high volumetric capacity. Similarly, it complies with the requirements of the Kyoto Protocol by helping to reduce the greenhouse effect.

### BRIEF DESCRIPTION OF THE DRAWINGS

In order to facilitate the description of the matters set out above some drawings are attached that show, schematically and solely by way of non-restrictive example, a practical case of embodiment of the gas aspiration and compression system of the invention, especially for gas compressors, in which:

FIG. 1 is a schematised view of the gas aspiration and compression system according to the invention;

FIG. 2 is a cross-section view of the piston showing the position of the gas-intake holes; and

FIG. 3 is a schematised section view of a single-stage refrigeration compressor that incorporates the gas aspiration and compression system of the invention.

### DESCRIPTION OF A PREFERRED EMBODIMENT

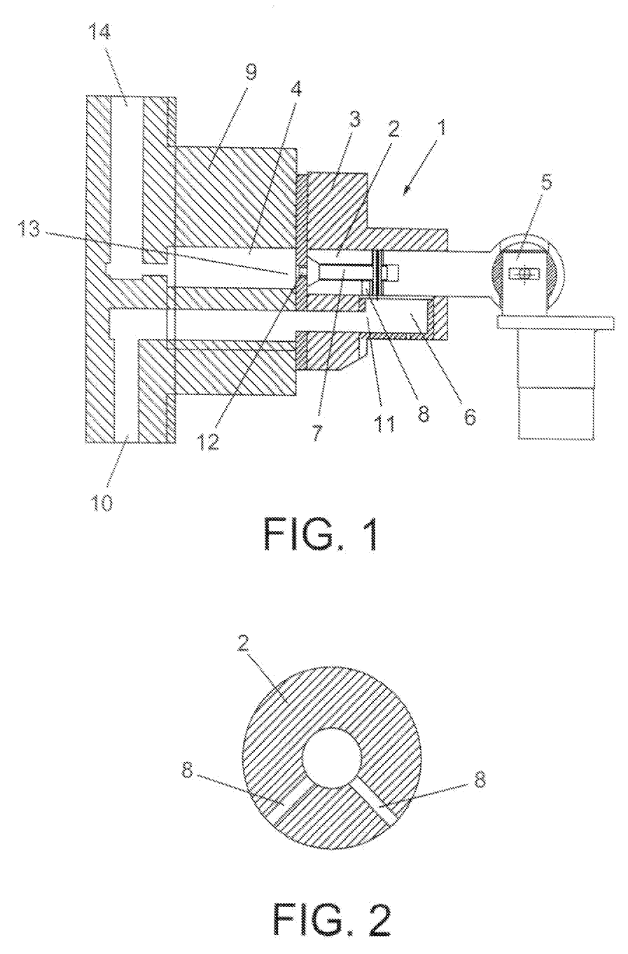

As can be seen in FIG. 1, the gas aspiration and compression system 1 of the invention includes a piston 2 of considerably small diameter, preferably less than 11 mm, associated with a cylinder 3 of a compression chamber 4, with said piston 2 being in this case coupled to a Scotch yoke mechanism 5. The system 1 of the invention also includes a gas intake port 6 positioned in a side zone of the cylinder 3 near the bottom dead point of the piston 2, a P-V optimisation valve 7 (Pressure-Volume) fitted centred inside the piston 2, and two holes 8 made in the piston 2 in a radial direction and connecting said intake port 6 with the P-V optimisation valve 7. The holes 8 of the piston 2 are thus moveable along the intake port 6, permitting entry of the gas towards the compression chamber 4 during the intake stroke of the piston 2, and closure of the gas during the compression stroke of the piston 2. Thanks to this arrangement, it is no longer necessary to use an intake valve.

FIG. 2 shows that the gas intake holes 8 are positioned in a plane other than the vertical and horizontal planes, for the purpose of preventing them undergoing the stresses pertaining to the reaction torque on the piston head 2 and on the rear part of the cylinder 3.

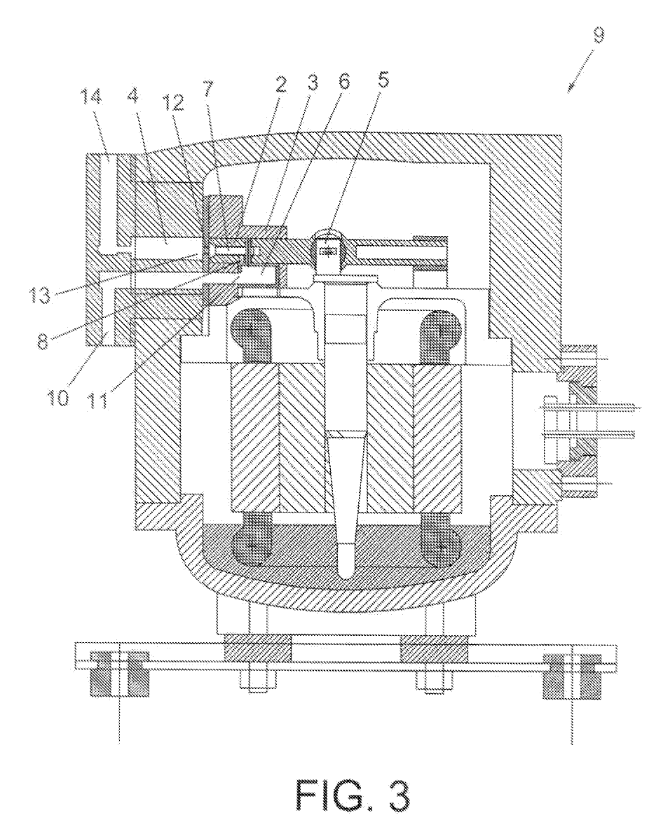

FIG. 3 shows the internal layout of a single-stage refrigeration compressor 9, with the gas aspiration and compression system 1 of the invention incorporated. The gas enters through the aspiration port 10, being taken as far as the intake port 6. When the piston 2 begins its intake stroke or withdrawal, the gas at low pressure penetrates into the housing of the P-V optimisation valve 7 through the holes 8. The difference of pressures between the vacuum produced by the withdrawal of the piston 2 and that of the gas in the intake port 6 opens the valve 7 and breaks the vacuum of the cylinder 3. When the piston head 2 reaches the end 11 of the port the gas penetrates abruptly into the cylinder 3 which is finishing filling, taking it up to the pressure existing at the intake port 6, during the remainder of the stroke of the piston 2.

The front part of the P-V optimisation valve 7 includes a projection 12 that can at the top dead point of the piston 2 occupy part of the volume of an exhaust port.

On the compression stroke, when point 11 is reached, the pressure in the cylinder 3 increases rapidly and closes the P-V optimisation valve 7. The pressure achieved opens an exhaust valve 13 and the compressed gas arrives at the exhaust port 14.

1. Gas aspiration and compression system (1), especially for gas compressors (9), of the type that includes a piston (2) of considerably small diameter associated with a cylinder (3) of a compression chamber (4), wherein it includes a gas intake port (6) positioned in a lateral zone of the cylinder (3) near the bottom dead point of the piston (2), a P-V optimisation valve (7) mounted inside the piston (2), and at least one hole (8) made in the piston (2) in a radial direction that connects said intake port (6) with the P-V optimisation valve (7), in such a way that at least one hole (8) is moveable along the intake port (6), thereby permitting entry of gas towards the compression chamber (4) during the intake stroke of the piston (2) and closing of the gas during the compression stroke of the piston (2).

2. System (1) according to claim 1, wherein the at least one hole (8) is positioned in a plane other than that which contains the stresses corresponding to the reaction torque on the piston head (2) and on the rear part of the cylinder (3).

3. System (1) according to claim 1, wherein the P-V optimisation valve (7) is mounted substantially centred in an axial direction inside the piston (2).

4. System (1) according to claim 1, wherein the front part of the P-V optimisation valve (7) includes a projection (12) that can occupy at the top dead point of the piston (2) part of the volume of a corresponding exhaust port.

5. System (1) according to claim 1, wherein the diameter of the piston (2) is less than 11 mm.

6. Gas compressor (9), comprising a gas aspiration and compression system (1) of the type defined according to claim 1.

7. Gas compressor (9), according to claim 8, wherein the gas is CO₂.

8. System (1) according to claim 1, wherein said gas is CO₂.
